(19) United States
(12) Patent Application Publication
(10) Pub. No.: US 2013/0257419 A1
(43) Pub. Date: Oct. 3, 2013

(54) MAGNETIC ENCODER SYSTEM FOR AIRCRAFT SEATING ACTUATOR

(71) Applicants: James Abraham Greenwell, cary, NC (US); Russell C. Proctor, Wake Forest, NC (US)

(72) Inventors: James Abraham Greenwell, cary, NC (US); Russell C. Proctor, Wake Forest, NC (US)

(73) Assignee: BE Aerospace, Inc., Wellington, FL (US)

(21) Appl. No.: 13/430,808

(22) Filed: Mar. 27, 2012

(51) Int. Cl. G01B 7/30

(52) U.S. Cl. 324/207.25

(57) ABSTRACT

A magnetic encoder system for providing positional feedback from an adjustable surface including first and second intermeshed encoder gears having different numbers of teeth such that the gears rotate different angular amounts depending on a gear tooth ratio, and magnetic encoder chips sensing rotation of the encoder gears and determining an angular relationship of the gears to determine the position of the adjustable surface.

### TECHNICAL FIELD AND BACKGROUND OF THE INVENTION

The present invention relates generally to the field of adjustable passenger seat control, and more particularly, to a magnetic encoder system for a seating actuator that utilizes geared encoders and angular relationships thereof to determine positions of adjustable seating surfaces.

Aircraft and other conveyances typically include passenger seats having adjustable seating surfaces for passenger comfort. While coach class seats often include reclining seatbacks that provide a degree of comfort, premium class seats can include seatbacks, seat pans and footrests that cooperatively adjust to achieve horizontal or “lie-flat” seating positions for providing the ultimate in comfort. Regardless of the type of seat or degree of adjustability thereof, it is necessary for positional information of seating surfaces to be stored so that seat positions can be known and control computers can locate the position of seat actuators.

One conventional system for providing positional feedback from a surface utilizes potentiometers associated with actuators that relay signals (i.e., angles) to a control computer. Known to those skilled in the art, potentiometers rely on physical contact to measure resistance changes as a mechanical finger traces a coil. The use of potentiometers, however, is undesirable in seating systems because position sensors that rely on physical contact are subject to physical failures due to oxidation, vibration, harmonics, electrical noise and wear.

To lessen the problems associated with physical contact sensors, magnetic encoder apparatus have been proposed for providing positional feedback. In such systems, a chip mounted on a circuit board can be used to measure the absolute angle of a rotating magnet, for example to determine reference positions of a motor. While the use of magnetic encoders is advantageous in that there is no physical contact, current systems employ single encoders which are capable of providing only 0-360-0 degree feedback. Thus, repetitive counting is not possible, for example, to determine if a measured part is on its 2^{nd} or 8^{th} revolution.

Accordingly, what is needed is a positional feedback system for adjustable seating surfaces that overcomes the disadvantages of physical contact position sensors, as well as a system capable of going over bounds without physical damage, i.e., an infinite system. Such systems would be particularly advantageous for use in aircraft seating applications in which measurable components undergo multiple revolutions to achieve the full range of motion of adjustable seating surfaces.

### BRIEF SUMMARY OF THE INVENTION

In one aspect, a non-contact, electronic positional feedback system is provided herein.

In another aspect, a boundless positional feedback system advantageous for use in adjustable passenger seat control applications is provided herein.

In yet another aspect, the positional feedback system is configured to count multiple revolutions of rotating components required to move a seating surface through its full range of motion.

In yet another aspect, the positional feedback system utilizes multiple uniquely geared encoders and angular relationships therebetween to know the position of adjustable seating surfaces, for example, for seat control.

To achieve the foregoing and other aspects and advantages, in one embodiment a magnetic encoder system for providing positional feedback from a surface is provided herein. The system includes first and second encoder gears that are intermeshed and have different numbers of gear teeth such that the first and second encoder gears rotate different angular amounts dependent on a gear tooth ratio, and first and second magnetic encoder chips sensing rotation of the first and second encoder gears and determining an angular relationship of the first and second encoder gears to determine a position of the surface.

The magnetic encoder system may be utilized with a housing and a shaft rotatably supported by the housing and coupled with a shaft gear meshed with at least one of the first and second encoder gears such that rotation of the shaft causes rotation of the first and second encoder gears. The shaft may be actuator driven to drive the movement of a seating surface. The housing rotatably supports the first and second encoder gears in sensing proximity of the first and second magnetic encoder chips, and the first and second encoder gears include a magnet rotatably coupled therewith.

The first encoder gear may include a greater number of gear teeth than the second encoder gear such that rotation of the first encoder gear causes the second encoder gear to rotate a different angular amount than the first encoder gear.

The magnetic encoder system may further include a controller for storing positional information of the first and second encoder gears and seating surface positional information, among other functions.

The first encoder gear and the first magnetic encoder chip together form a first encoder, and the second encoder gear and the second magnet encoder chip together form a second encoder, wherein the second encoder is geared differently than the first encoder.

In another embodiment, a magnetic encoder system for providing positional feedback from an adjustable seating surface is provided herein including first and second intermeshed encoder gears having different numbers of gear teeth such that the gears rotate different angular amounts dependent on a gear tooth ratio, a magnet coupled in rotation with each of the first and second encoder gears, and first and second magnetic encoder chips sensing rotation of the magnet of each of the first and second encoder gears.

In a further embodiment, a method of sensing positional feedback from an adjustable seating surface is provided herein including the steps of: (i) providing a rotating shaft; (ii) providing a magnetic encoder system rotatably coupled to the rotating shaft and including first and second encoder gears that are meshed together that have different numbers of gear teeth such that the first and second encoder gears rotate different angular amounts dependent on a gear tooth ratio, and first and second magnetic encoder chips sensing rotation of the first and second encoder gears and an angular relationship of the first and second encoder gears; (iii) rotating the shaft; (iv) sensing rotation of the first encoder with respect to the first magnetic encoder chip and rotation of the second encoder gear with respect to the second magnetic encoder chip; and (v) determining the angular relationship between the first and second encoder gears to determine a position of the adjustable seating surface.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of a magnetic encoder system according to an embodiment of the invention shown associated with an output shaft of an adjustable passenger seat;

FIG. 2 is another perspective view of the magnetic encoder system showing the electronics;

FIG. 3 is a plan view of the gear side of the magnetic encoder system;

FIG. 4 is a perspective view of the gear side of the magnetic encoder system;

FIG. 5 is a plan view of the electronics side of the magnetic encoder system;

FIG. 6 is an exploded perspective view of the electronics side of the magnetic encoder system;

FIG. 7 is a perspective view of the magnetic encoder system housing shown with the electronics and gears removed;

FIG. 8 is a schematic diagram showing the positions of the meshed gears at a starting position;

FIG. 9 is a schematic diagram showing the positions of the meshed gears at 1 full turn of the 10-toothed gear; and

FIG. 10 shows an arrangement of a magnetic encoder system in accordance with an embodiment of the invention.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

The magnetic encoder system described and shown herein is used to provide positional feedback information from a surface so that the position of the surface can be known. Such a system is particularly advantageous for use in aircraft seating applications including adjustable seating surfaces wherein movement is actuator driven and computer controlled. While the magnetic encoder system is described herein with reference to seating applications, it is not intended that the invention be limited only to such applications, as it is envisioned that this system can be used in any application that may benefit from a non-physical contact positional feedback system.

Referring to the figures, the embodiments of magnetic encoder systems for providing positional feedback from an adjustable surface generally include magnetic encoders that sense revolutions of intermeshed encoder gears to determine angular relationships between the gears. The angular relationships of the encoder gears correspond to positions of an adjustable surface, such that the position of the surface can be determined from the angular relationships. Positional information of the adjustable surface can be stored such that a seat controller can locate the positions of actuators driving movement of adjustable surfaces. Thus, the systems provided herein allow it to be immediately known where adjustable surfaces are positioned based on the angular relationship between the gears. The adjustable surfaces may be actuator driven seating surfaces such as adjustable seatbacks, seat pans, legrests, footrests, armrests and headrests, among others.

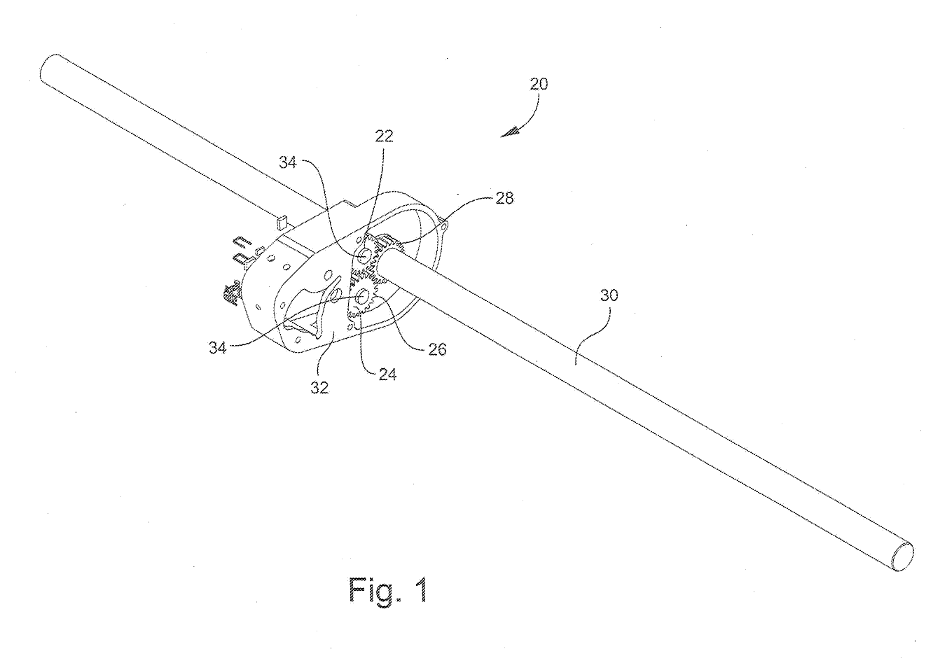

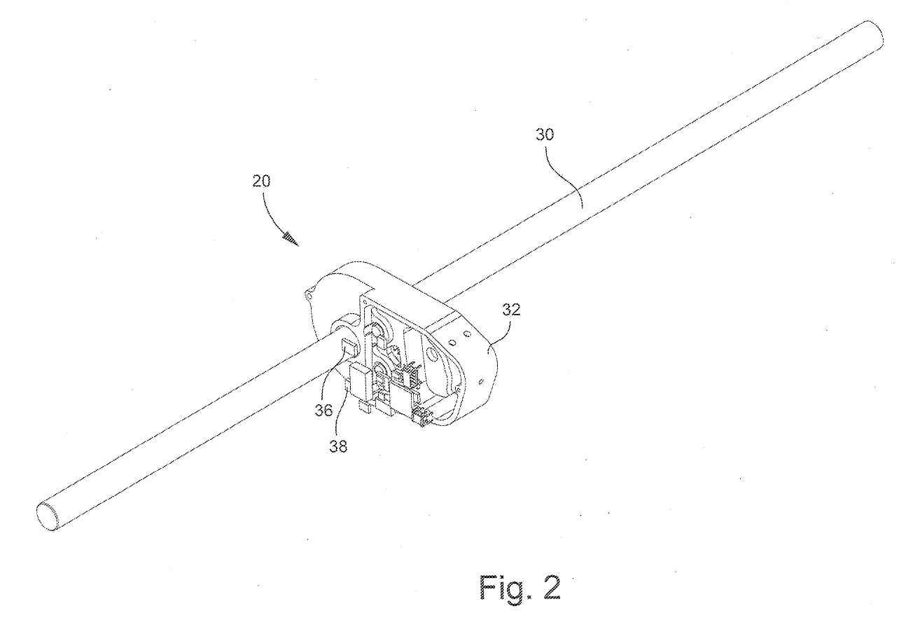

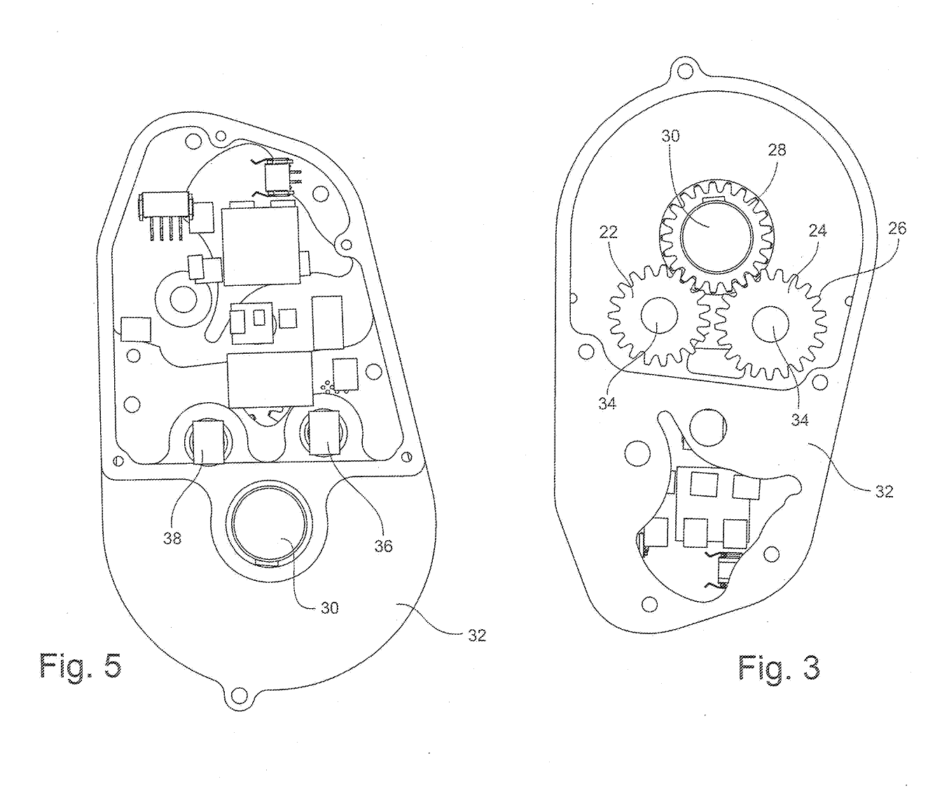

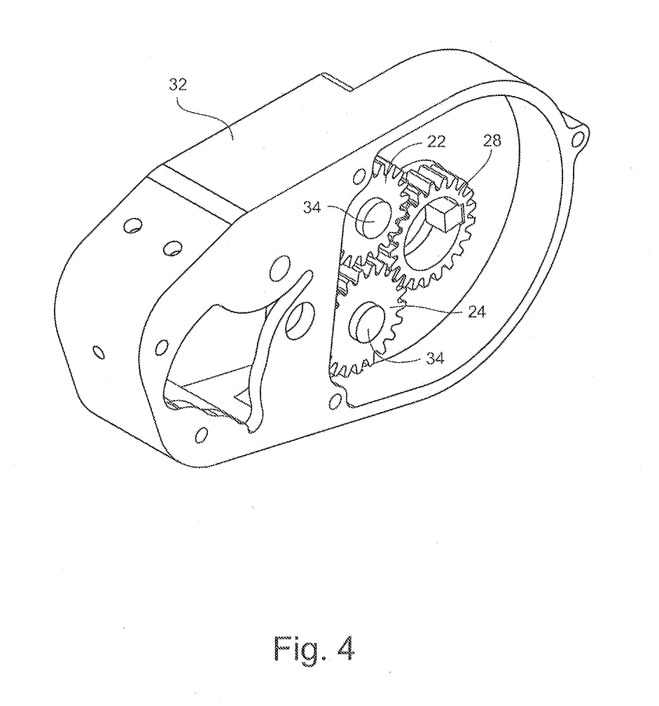

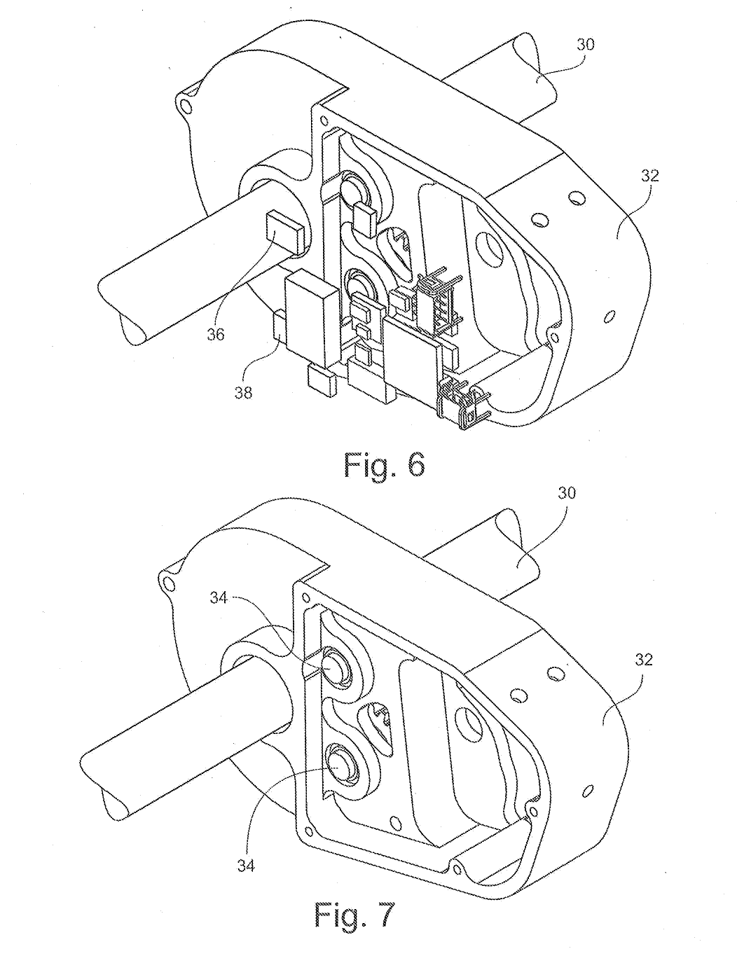

Referring to FIGS. 1-7, a first embodiment of a magnetic encoder system is shown generally at reference numeral 20. The system 20 generally includes first and second encoder gears 22, 24 intermeshed and having different numbers of gear teeth 26 such that the first and second encoder gears rotate different angular amounts dependent on their gear tooth ratio. As shown in FIGS. 1-2, the first and second encoder gears 22, 24 are meshed with a shaft gear 28 coupled to a rotating shaft 30, such that rotation of shaft 30 causes rotation of both the first and second encoder gears.

The magnetic encoder system 20 further includes a housing 32 rotatably supporting the shaft 30. As shown, the housing 32 rotatably supports the first and second encoder gears 22, 24 and the shaft gear 28 on one side of the housing. The first and second encoder gears 22, 24 rotate simultaneously upon rotation of the shaft 30. Each of the first and second encoder gears 22, 24 carries a magnet 34 thereon of the type capable of being sensed by magnetic encoder chips known to those skilled in the art. Each magnet 34 may, for example, be in the form of a diametric magnet mounted axially on its gear.

First and second magnetic encoder chips 36, 38 for sensing rotation of the first and second encoder gears 22, 24, respectively, are positioned in sensing proximity of the magnets 34 of the encoder gears. The magnetic encoder chips 36, 38 are operable for measuring the angle of the magnetic field passed therethrough to determine the amount of rotation of the magnets relative to the chips. The magnetic encoder chips 36, 38 may be a located on a seat control circuit board or another printed circuit board in communication with the seat controller.

The first and second encoder gears 22, 24 have different numbers of gear teeth 26 such that the first and second encoder gears rotate different angular amounts dependent on their gear tooth ratio. The first encoder gear 22 and the first magnetic encoder chip 36 together form a first encoder, and the second encoder gear 24 and the second magnet encoder chip 38 together form a second encoder, wherein the second encoder is geared differently than the first encoder. The system may include additional encoders, and may include multiple sets of encoders on the same seat for sensing the movements of the different adjustable seating surfaces.

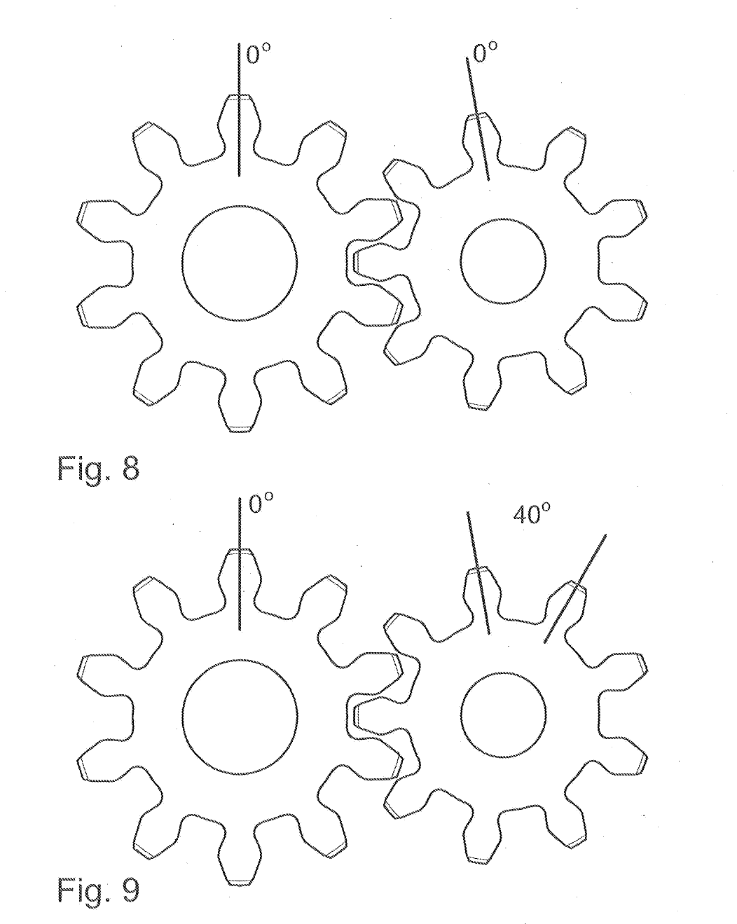

Referring to FIGS. 8-9, in one example, the first encoder gear 22 may have 10 gear teeth 26 and the second encoder gear 24 may have 9 gear teeth. In this example, the first and second encoder gears 22, 24 are meshed and have a gear tooth ratio when the gears rotate the second gear 24 rotates a greater angular amount than the first gear 22.

Referring to FIG. 8, the first and second encoder gears 22, 24 are shown positioned at “start” positions where a reference point on each of the first and second gears measures 0 degrees. Referring to FIG. 9, after one full rotation or turn of the first encoder gear 22, the first encoder gear again measures 0 degrees, but the second encoder gear 24 measures 40 degrees. This increment of the second encoder gear 24 (i.e., the 9-toothed gear) continues for nine full rotations, therefore, not repeating until the tenth rotation of the first encoder gear 22 (i.e., the 10-toothed gear). This exemplary encoder gear arrangement provides a unique combination of positions for up to ten rotations. The number of rotations possible with the encoder gear arrangement may only be limited by the physical size restrictions of the gears and the resolution of each magnetic encoder chip. While two encoder gears are shown, the system may be expanded to include any number of chips and gears to add additional turns of capability.

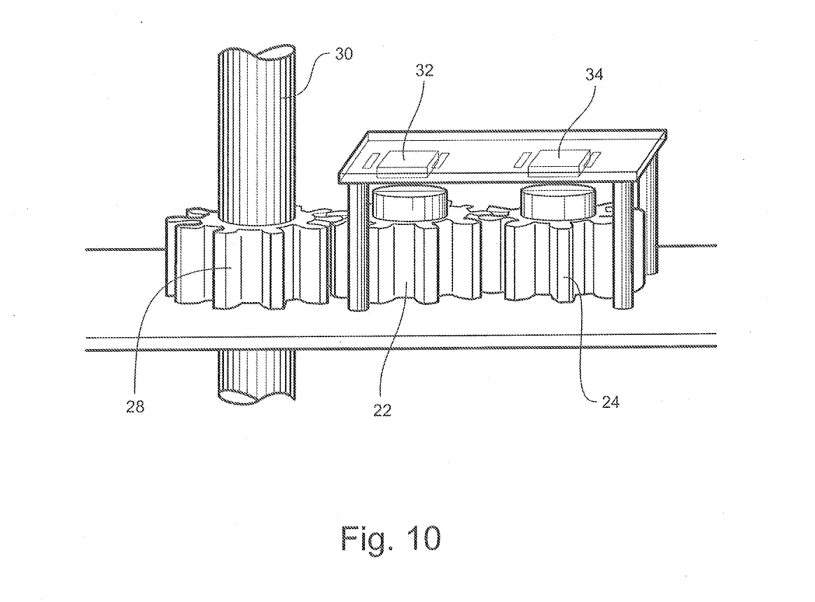

Referring to FIG. 10, in a second embodiment the rotating shaft 30 drives the rotation of the second encoder gear 24 through the first encoder gear 22. Thus, the second encoder gear 24 is not directly meshed with the rotating shaft 30. The rotating shaft 30 may be driven, for example, by an actuator for driving the movement of a seating surface through its range of motion. The first and second magnetic encoder chips 36, 38 are positioned in alignment with their respective encoder gear for sensing rotations, such as axially aligned therewith as shown.

In a further embodiment, a method of sensing positional feedback from an adjustable seating surface of an aircraft passenger seat is provided herein. The method includes the steps of: (i) providing a rotating shaft, such as a shaft of an actuator driving movement of an adjustable seating surface; (ii) providing a magnetic encoder system rotatively coupled to the rotating shaft and including first and second encoder gears that are intermeshed and have different numbers of gear teeth such that the first and second encoder gears rotate different angular amounts dependent on a gear tooth ratio, and first and second magnetic encoder chips sensing rotation of the first and second encoder gears and an angular relationship of the first and second encoder gears; (iii) rotating the shaft; (iv) sensing rotation of the first and second encoder gears using the first and second magnetic encoder chips; and (v) determining the angular relationship of the first and second gears to determine the position of the adjustable seating surface.

The foregoing description provides embodiments of the invention by way of example only. It is envisioned that other embodiments may perform similar functions and/or achieve similar results. Any and all such equivalent embodiments and examples are within the spirit and scope of the present invention and are intended to be covered by the appended claims.

What is claimed is:

1. A magnetic encoder system for providing positional feedback from an adjustable surface, comprising:
first and second encoder gears that are intermeshed and have different numbers of gear teeth such that the first and second encoder gears rotate different angular amounts dependent on a gear tooth ratio; and
first and second magnetic encoder chips that sense rotation of the first and second encoder gears to determine angular relationships of the first and second encoder gears that correspond to positions of the adjustable surface.

2. The magnetic encoder system according to claim 1, further comprising:
a housing; and
a shaft rotatably supported by the housing and coupled with a shaft gear meshed with at least one of the first and second encoder gears such that rotation of the shaft causes rotation of the first and second encoder gears.

3. The magnetic encoder system according to claim 1, wherein the housing rotatably supports the first and second encoder gears in sensing proximity of the first and second magnetic encoder chips.

4. The magnetic encoder system according to claim 1, wherein the first and second encoder gears each include a magnet rotatively coupled therewith.

5. The magnetic encoder system according to claim 1, wherein the first encoder gear includes a greater number of gear teeth than the second encoder gear such that rotation of the first encoder gear causes the second encoder gear to rotate a different angular amount than the first encoder gear.

6. The magnetic encoder system according to claim 1, further comprising a controller for storing positional information of the first and second encoder gears.

7. The magnetic encoder system of claim 1, wherein the rotating shaft drives movement of an adjustable seating surface of an aircraft passenger seat.

8. The magnetic encoder system of claim 1, wherein the first encoder gear and the first magnetic encoder chip together form a first encoder, and the second encoder gear and the second magnet encoder chip together form a second encoder, wherein the second encoder is geared differently than the first encoder.

9. A magnetic encoder system for providing positional feedback from an adjustable seating surface, comprising:
first and second intermeshed encoder gears having different numbers of gear teeth such that the gears rotate different angular amounts dependent on a gear tooth ratio;
a magnet coupled in rotation with each of the first and second encoder gears; and
first and second magnetic encoder chips sensing rotation of the magnet of each of the first and second encoder gears.

10. The magnetic encoder system according to claim 9, further comprising:
a rotating shaft rotatively coupled with a shaft gear meshed with at least one of the first and second encoder gears.

11. The magnetic encoder system according to claim 9, wherein the first encoder gear includes a greater number of gear teeth than the second encoder gear such that rotation of the first encoder gear causes the second encoder gear to rotate a different angular amount than the first encoder gear.

12. The magnetic encoder system according to claim 9, further comprising a controller for storing positional information of the first and second encoder gears.

13. A method of sensing positional feedback from an adjustable seating surface, comprising the steps of:
providing a rotating shaft;
providing a magnetic encoder system rotatively coupled to the rotating shaft and including first and second encoder gears that are intermeshed and have different numbers of gear teeth such that the first and second encoder gears rotate different angular amounts dependent on a gear tooth ratio, and first and second magnetic encoder chips sensing rotation of the first and second encoder gears and an angular relationship of the first and second encoder gears;
rotating the shaft;
sensing rotation of the first encoder with respect to the first magnetic encoder chip and rotation of the second encoder gear with respect to the second magnetic encoder chip; and
determining the angular relationship of the first and second encoder gears to determine a position of the adjustable seating surface.

14. The method according to claim 13, wherein the first encoder gear includes a greater number of gear teeth than the second encoder gear such that rotation of the first encoder gear causes the second encoder gear to rotate a different angular amount than the first encoder gear.

15. The method according to claim 13, further comprising providing a controller and storing positional information of the first and second encoder gears.
